(19) United States
(12) Patent Application Publication
(10) Pub. No.: US 2025/0159594 A1
(43) Pub. Date: May 15, 2025

(54) ELECTRONIC DEVICE FOR PERFORMING EASY SETUP, USER TERMINAL DEVICE, AND CONTROL METHODS THEREOF

(71) Applicant: SAMSUNG ELECTRONICS CO., LTD., Suwon-si (KR)

(72) Inventors: Hyunsoo KIM, Suwon-si (KR); Jinhwan KIM, Suwon-si (KR); Seongil HAHM, Suwon-si (KR)

(73) Assignee: SAMSUNG ELECTRONICS CO., LTD., Suwon-si (KR)

(21) Appl. No.: 19/022,338

(22) Filed: Jan. 15, 2025

Related U.S. Application Data
(63) Continuation of application No. PCT/KR2023/011539, filed on Aug. 7, 2023.

(30) Foreign Application Priority Data
Sep. 29, 2022 (KR) 10-2022-0124371

(51) Int. Cl. H04W 48/16; H04W 48/20

(52) U.S. Cl. CPC H04W 48/16; H04W 48/20

(57) ABSTRACT

An electronic device comprises a communication interface and at least one processor connected to the communication interface to control the electronic device. The at least one processor operates as a soft access point and, based on a channel being established with a user terminal device, scans for one or more access points near the electronic device; control the communication interface to transmit information related to the one or more access points obtained based on the scan to the user terminal device; receive information related to one of the one or more access points from the user terminal device via the communication interface; and control the communication interface to transmit a connection request to the one of the one or more access points on the basis of the information related to the one access point.

### CROSS-REFERENCE TO RELATED APPLICATION

This application is a continuation application is a continuation application, under 35 U.S.C. § 111(a), of international application No. PCT/KR2023/011539, filed Aug. 7, 2023, which claims priority under 35 U. S. C. § 119 to Korean Patent Application No. 10-2022-0124371, filed Sep. 29, 2022, the disclosures of which are incorporated herein by reference in their entireties

### TECHNICAL FIELD

The disclosure relates to an electronic device, a user terminal device, and control methods thereof and more particularly, to an electronic device for performing an easy setup, a user terminal device, and control methods thereof.

### BACKGROUND ART

Thanks to the development of electronic technologies, various types of electronic devices have been developed. In particular, as Internet of Things (IoT) devices have been recently distributed, user convenience has been enhanced.

Meanwhile, since many IoT devices mostly do not include a display, there is a problem that information delivery is difficult. In particular, there is a problem that it is difficult for a user to connect IoT devices to the Internet.

The problem as above may be solved by a smart phone. Specifically, the problem may be solved through a method that the smart phone arbitrates in a process of connecting the IoT devices to the Internet and registering the IoT devices at an IoT server at the same time. This method is referred to as an easy setup, onboarding, or commissioning.

### DISCLOSURE

### Technical Solution

According to an embodiment of the disclosure, to achieve the purpose as above, an electronic device includes a communication interface, and at least one processor connectable to the communication interface to control the electronic device, wherein the processor is configured to based on a channel for communication with a user terminal device being formed by operating as a soft access point, scan for at least one access point around the electronic device, control the communication interface to transmit information related to the at least one access point obtained based on the scan to the user terminal device, receive information related to one access point among the at least one access point from the user terminal device through the communication interface, and control the communication interface to transmit a connection request to the one access point among the at least one access point based on the information related to the one access point.

Also, the information related to the one access point may include at least one of identification information of the one access point or a password of the one access point.

Meanwhile, according to an embodiment of the disclosure, a user terminal device includes a communication interface, and at least one processor connectable to the communication interface to control the user terminal device, wherein the processor is configured to receive information related to a first access point from a first electronic device through the communication interface, based on a channel for communication with a second electronic device being formed, receive information related to at least one second access point from the second electronic device through the communication interface, and based on the first access point being included among the information related to the at least one second access point, control the communication interface to transmit information related to the first access point to the second electronic device.

Also, the at least one processor may identify a signal strength of the first access point in the second electronic device based on information related to the at least one second access point, and based on the signal strength being equal to or greater than preset signal strength, may control the communication interface to transmit the information related to the first access point to the second electronic device.

Further, the information related to the first access point may include first signal strength of the first access point in the first electronic device, wherein the processor may identify second signal strength of the first access point in the second electronic device based on the information related to the at least one second access point, and based on the second signal strength being equal to or greater than the first signal strength or the preset signal strength, may control the communication interface to transmit the information related to the first access point to the second electronic device.

Also, the user terminal device may further include a display, wherein the processor, based on a preset application being executed, may control the display to display a list related to at least one electronic device related to the application, and based on the second electronic device being selected among the at least one electronic device, may receive the information related to the first access point from the first electronic device through the communication interface.

Further, the processor, based on the second electronic device being selected among the at least one electronic device, may control the communication interface to transmit a signal requesting information related to access points of which each is connected to the at least one electronic device.

Also, the processor, based on the second electronic device and a position corresponding to the second electronic device being selected, may receive the information related to the first access point and information related to a position of the first electronic device from the first electronic device through the communication interface, and based on the position of the first electronic device and the position of the second electronic device being identical and the first access point being included in the at least one second access point, may control the communication interface to transmit the information related to the first access point to the second electronic device.

Further, the user terminal device may further include a display, wherein the processor, based on the first access point being not included among the information related to the at least one second access point, may control the display to display a screen for receiving the information related to the first access point.

Also, the information related to the first access point may include at least one of identification information of the first access point or a password of the first access point.

Meanwhile, according to an embodiment of the disclosure, a control method of an electronic device includes based on a channel for communication with a user terminal device being formed by operating as a soft access point, scanning for at least one access point around the electronic device, transmitting information related to at least one access point to the user terminal device, receiving information related to the at least one access point among the at least one access point from the user terminal device, and transmitting a connection request to the at least one access point among the at least one access point based on information related to the one access point.

Also, the information related to the one access point may include at least one of identification information of the one access point or a password of the one access point.

Meanwhile, according to an embodiment of the disclosure, a method of controlling a user terminal device includes receiving information related to a first access point from a first electronic device, based on a channel for communication with a second electronic device being formed, receiving information related to at least one second access point from the second electronic device, and based on the first access point being included in the at least one second access point, transmitting information related to the first access point to the second electronic device.

Also, the transmitting may include identifying signal strength of the first access point in the second electronic device based on information related to the at least one second access point, and based on the signal strength being equal to or greater than preset signal strength, transmitting the information related to the first access point to the second electronic device.

Further, the information related to the first access point may include first signal strength of the first access point in the first electronic device, wherein the transmitting may include identifying second signal strength of the first access point in the second electronic device based on the information related to the at least one second access point, and based on the second signal strength being equal to or greater than the first signal strength or the preset signal strength, transmitting the information related to the first access point to the second electronic device.

Also, the method may include, based on a preset application being executed, displaying a list related to at least one electronic device related to the application, wherein the receiving the information related to the first access point may include, based on the second electronic device being selected among the at least one electronic device, receiving the information related to the first access point from the first electronic device.

Further, the receiving the information related to the first access point may include, based on the second electronic device being selected among the at least one electronic device, transmitting a signal requesting information related to access points of which each is connected to the at least one electronic device.

Also, the receiving the information related to the first access point may include, based on the second electronic device and a position corresponding to the second electronic device being selected, receiving the information related to the first access point and information related to a position of the first electronic device from the first electronic device, and the transmitting may include, based on the position of the first electronic device and the position of the second electronic device being identical and the first access point being included in the at least one second access point, transmitting the information related to the first access point to the second electronic device.

Further, the method may further include, based on the first access point being not included in the at least one second access point, displaying a screen for receiving the information related to the first access point.

Also, the information related to the first access point may include at least one of identification information of the first access point or a password of the first access point.

### DESCRIPTION OF DRAWINGS

FIGS. 1A and 1B are views illustrating an easy setup according an embodiment;

FIG. 2 is a block diagram illustrating an electronic system according to an embodiment;

FIG. 3 is a block diagram illustrating a second electronic device according to an embodiment;

FIG. 4 is a block diagram illustrating a configuration of a user terminal device according to an embodiment;

FIG. 5 is a block diagram illustrating a detailed configuration of a user terminal device according to an embodiment;

FIG. 6 is a sequence diagram illustrating an easy setup according to an embodiment;

FIG. 7 is a sequence diagram illustrating a data flow according to an embodiment;

FIG. 8 is a sequence diagram illustrating an easy setup in consideration of position information according to an embodiment;

FIG. 9 is a flow chart illustrating a method of controlling an electronic device according to an embodiment; and

FIG. 10 is a flow chart illustrating a method of controlling a user terminal device according to an embodiment.

### MODE FOR INVENTION

An aspect of the disclosure is to provide an electronic device which performs an easy setup without information input about an access point to enhance user convenience, a user terminal device, and control methods thereof.

The disclosure is specifically described with reference to the appended drawings hereinafter.

The terms used in embodiments of the disclosure are selected as general terms which are currently widely used as much as possible in consideration of functions in the disclosure but may be varied depending on intention of those skilled in the art or a precedent, appearance of new technologies, or the like. Also, there is a term which is arbitrarily selected by the applicant in a certain case and in this case, its meaning will be specifically described in the relevant description part of the disclosure. Therefore, the term used in the disclosure should be defined based on the meaning of the term and the entire content throughout the disclosure rather than the simple name of the term.

In the specification, the expression such as “have”, “may have”, “include”, or “may include” denotes the existence of such characteristics (e.g. a numerical value, a function, an operation, and a component such as a part) and does not exclude the existence of additional characteristics.

The expression “at least one of A and/or B” should be interpreted to mean any one of “A” or “B” or “A and B”.

The expression “1st”, “2nd”, “first”, “second”, or the like used in the specification may be used to describe various elements regardless of any order and/or degree of importance, wherein such expression is used only to distinguish one element from another element and is not intended to limit the relevant element.

A singular expression includes a plural expression, unless obviously differently defined in the context. In the application, the term such as “include” or “consist of” should be construed as designating that there are such characteristics, numbers, steps, operations, components, parts, or a combination thereof described in the specification but not as excluding in advance possibility of the existence or addition of one or more other characteristics, numbers, steps, operations, components, parts, or a combination thereof.

In the disclosure, the term “user” may be referred to as a person who uses an electronic device or a device which uses the electronic device (e.g. an artificial intelligence (AI) electronic device).

Hereinafter, various embodiments of the disclosure are more specifically described with reference to the appended drawings.

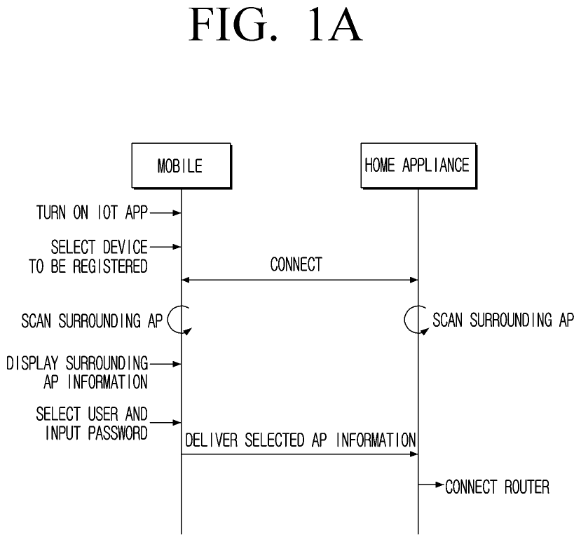

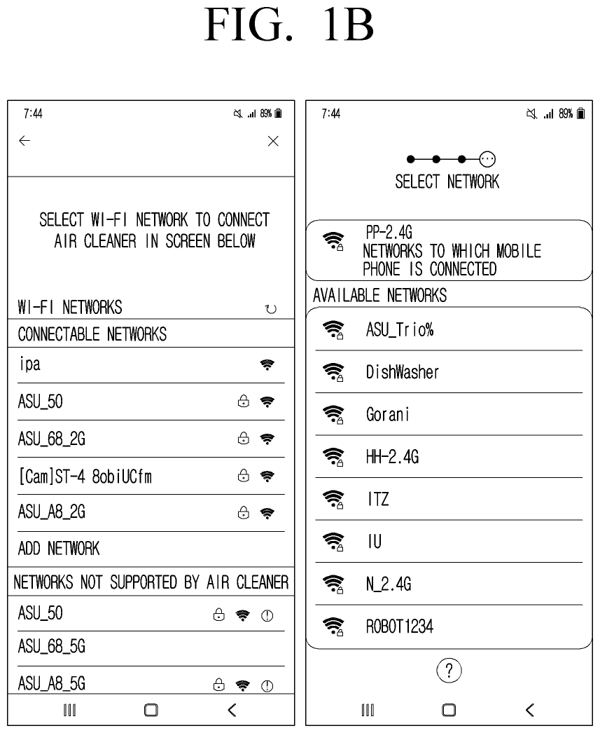

FIGS. 1A and 1B are views illustrating an easy setup according an embodiment.

Conventionally, a user has performed state monitoring and remote control of surrounding IoT devices through near field communication such as Zigbee or Bluetooth. In this case, at-home devices may not be remotely controlled outside, wherein an infrastructure for communication through Wi-Fi or cellular communication is few and additional costs occur for establishing this system. Therefore, there is a limitation.

After popularization of a smart phone, it has become possible to be connected to the Internet even outside and a wireless network has been established through Wi-Fi even at home thanks to the distribution of a high-speed communication network and a wired/wireless router. That is, it has become possible to monitor and control IoT devices at home through a smart phone even outside. In this case, the IoT devices should be connected to the Internet at home and sharing information needs to be provided to the IoT devices.

Meanwhile, there are many cases that the IoT devices do not include a touch screen like that of a smart phone and thus user input is very limited. Accordingly, there is a problem that it is difficult for users to connect the IoT devices to the Internet.

As a method for solving this problem, an easy setup is a method of connecting the IoT device to the Internet and registering it at a IoT server by using a smart phone at the same time, wherein the easy setup is referred to as onboarding or commissioning and a device helping onboarding such as a smart phone and a smart TV is referred to as an onboarding helper or a commissioner.

For example, a user may execute an IoT application in a mobile device and select a home appliance to be registered as shown in FIG. 1A. The mobile device may be connected to the home appliance operating in a state of a soft access point, scan a surrounding access point, and display the scanned access point. The user may select one of displayed access points and input a password of the selected access point and the mobile device may transmit information about the selected access point to the home appliance. The home appliance, if receiving information about the access point from the mobile device, may turn off the soft access point, turn on a station mode, and be connected to the access point. The home appliance may register the home appliance at an IoT server for an IoT service and may form a device to server (D2S) communication channel between the home appliance and the IoT server.

The mobile device may receive a notification of registration completion from the IoT server.

As above, it is described as an example that the home appliance operates with a soft access point for D2D operation but the disclosure is not limited thereto, wherein the home appliance may perform BLE advertising.

Meanwhile, in a process as above, there is possibility that a user may not remember or may wrongly input a name or a password of the access point. For example, as shown in FIG. 1B, if the mobile device displays information about a plurality of access points, a user may confuse or wrongly select a desired access point. Also, there is high possibility that the user does not remember the password of the access point after initial installation, wherein it is forcibly required that the password of the access point include a special character and thus there is high possibility that the user confuses the password and even though the user remembers the password, there is possibility that an typographical error occurs in an input process.

Accordingly, as initial registration of the IoT devices fails and a negative user experience is provided, it may have a bad influence on a consumer and a manufacturer.

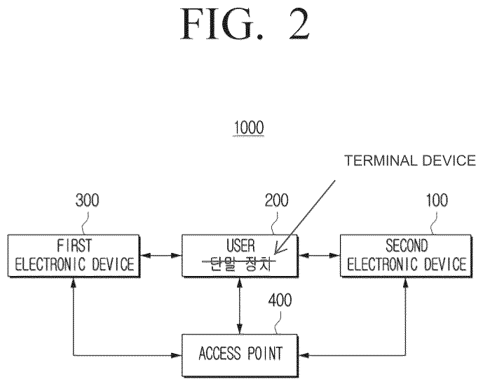

FIG. 2 is a block diagram illustrating an electronic system 1000 according to an embodiment. As shown in FIG. 2, the electronic system 1000 includes a second electronic device 100, a user terminal device 200, a first electronic device 300, and an access point 400.

The second electronic device 100 may be a device connected to the access point 400 by assistance of the user terminal device 200, as an IoT device. For example, the second electronic device 100 may be a washing machine, a refrigerator, a freezer, a dishwasher, a robot vacuum cleaner, etc.

The second electronic device 100 may operate with a soft access point and if a communication channel for communication with the user terminal device 200 is formed, scan at least one access point around the second electronic device 100, and transmit information about at least one access point to the user terminal device 200.

The user terminal device 200 may include a display as a device performing an easy setup and may be a device assisting that the second electronic device 100 is connected to the access point 400. For example, the user terminal device 200 may be a smart phone, a tablet PC, a desktop PC, a notebook, a TV, etc. Meanwhile, the disclosure is not limited thereto and the user terminal device 200 may be any device which performs the easy setup.

The user terminal device 200 may use information about the access point 400 to which the first electronic device 300 is connected from the first electronic device 300 to perform the easy setup about the second electronic device 100. For example, the user terminal device 200 may receive information about the access point 400 to which the first electronic device 300 is connected from the first electronic device 300 and if the second electronic device 100 may be connected to the access point 400 to which the first electronic device 300 is connected, may provide information about the access point 400 to which the first electronic device 300 is connected to the second electronic device 100 and may perform the easy setup about the second electronic device 100.

The first electronic device 300 may be a device connected to the access point 400, as an IoT device. For example, the second electronic device 100 may be a washing machine, a refrigerator, a freezer, a dishwasher, a robot vacuum cleaner, or the like and may be in a state connected to the access point 400 differently from the first electronic device 300.

The first electronic device 300 may transmit information about the access point 400 to the user terminal device 200. For convenience of the description of FIG. 2, it is shown that the first electronic device 300 is directly connected to the user terminal device 200 but is not limited thereto. For example, the first electronic device 300 may transmit information about the access point 400 to the IoT server and the IoT server may transmit information about the access point 400 to the user terminal device 200. Also, the information about the access point 400 may be transmitted via the access point 400 in each transmission process.

The access point 400 may be a device assisting in connecting a wireless communicatable device to a network.

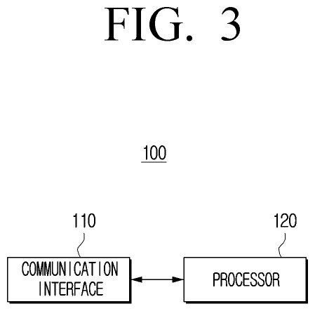

FIG. 3 is a block diagram illustrating a configuration of a second electronic device 100 according to an embodiment. According to FIG. 3, the second electronic device 100 includes a communication interface 110 and a processor 120.

The communication interface 110 is a component performing communication with various types of external devices according to various types of communication methods. For example, the second electronic device 100 may perform communication with the user terminal device 200 or the access point 400 through the communication interface 110.

The communication interface 110 may include a Wi-Fi module, a Bluetooth module, an infrared communication module, a wireless communication module, etc. Here, each communication module may be implemented in a form of at least one hardware chip. The Wi-Fi module and the Bluetooth module perform communication in a Wi-Fi method and a Bluetooth method, respectively. In case of using the Wi-Fi module or the Bluetooth module, the module may receive and transmit various connection information such as a SSID and a session key in advance, connect communication by using the connection information, and then receive and transmit various information. The infrared communication module may perform communication based on an infrared data association (IrDA) technology which transmits data wirelessly in a short distance by using infrared light between visible light and a millimeter wave.

The wireless communication module may include at least one communication chip performing communication according to various wireless communication standards such as Zigbee, a 3rd generation (3G), a 3rd generation partnership project (3GPP), long term evolution (LTE), LTE Advanced (LTE-A), a 4th generation (4G), and a 5th generation (5G).

Otherwise, the communication interface 110 may include a wired communication interface such as a HDMI, DP, Thunderbolt, a USB, RGB, a D-SUB, a DVI, or the like.

Besides, the communication interface 110 may include at least one of a local area network (LAN) module, an Ethernet module, or a wired communication module performing communication by using a pair cable, a coaxial cable, a fiber optic cable, or the like.

The communication interface 110 may be implemented as one communication interface or may be implemented as a plurality of communication interfaces. Meanwhile, hereinafter, for convenience of the description, operations of the second electronic device 100 are described based on the expression “communication interface 110”.

The processor 120 controls operations of the second electronic device 100 overall. Specifically, the processor 120 may be connected to each component of the second electronic device 100 to control operations of the second electronic device 100 overall. For example, the processor 120 may be connected to a component such as the communication interface 110, memory (not shown), or the like to control operations of the second electronic device 100. At least one processor 120 may include one or more of a Central Processing Unit (CPU), a Graphics Processing Unit (GPU), an Accelerated Processing Unit (APU), a Many Integrated Core (MIC), a Digital Signal Processor (DSP), a Neural Processing Unit (NPU), a hardware accelerator, or a machine learning accelerator. The at least one processor 120 may control one or any combination of other components of the second electronic device 100 and perform an operation related to communication or data processing. The at least one processor 120 may perform one or more programs or instructions stored in the memory. For example, the at least one processor 120 may perform a method according to an embodiment of the disclosure by executing one or more instructions stored in the memory.

If a method according to an embodiment of the disclosure includes a plurality of operations, the plurality of operations may be performed by one processor and may be performed by a plurality of processors. For example, when a first operation, a second operation, and a third operation are performed by a method according to an embodiment, all of the first operation, the second operation, and the third operation may be performed by a first processor and also, the first operation and the second operation are performed by the first processor (e.g. a general purpose processor) and the third operation may be performed by a second processor (e.g. an Artificial Intelligence (AI)-dedicated processor).

The at least one processor 120 may be implemented as a single core processor including one core and may be implemented as one or more multi core processors including a plurality of cores (e.g. homogeneous multicores or heterogeneous multicores). If the at least one processor 120 is implemented as a multi core processor, each of the plurality of cores included in the multi core processor may include processor internal memory such as cache memory and on-chip memory, wherein a common cache shared by the plurality of cores may be included in the multi core processor. Also, each of the plurality of cores included in the multi core processor (or part of the plurality of cores) may read and perform program instructions for independently implementing a method according to an embodiment of the disclosure and also, may read and perform program instructions for implementing a method according to an embodiment of the disclosure in connection with all (or part) of the plurality of cores.

If a method according to an embodiment of the disclosure includes a plurality of operations, the plurality of operations may be performed by one core among the plurality of cores included in the multi core processor and may be performed by the plurality of cores. For example, when a first operation, a second operation, and a third operation are performed by a method according to an embodiment, all of the first operation, the second operation, and the third operation may be performed by a first core included in the multi core processor and also, the first operation and the second operation may be performed by the first core included in the multi core processor and the third operation may be performed by a second core included in the multi core processor.

In embodiments of the disclosure, at least one processor 120 may mean a System on Chip (SoC) onto which one or more processors and other electronic components are integrated, a single core processor, a multi core processor, or a core included in the single core processor or the multi core processor, wherein the core may be implemented as a CPU, a GPU, an APU, a MIC, a DSP, a NPU, a hardware accelerator, or a machine learning accelerator but embodiments of the disclosure are not limited thereto. Meanwhile, hereinafter, for convenience of the description, operations of the second electronic device 100 are described based on the expression “processor 120”.

The processor 120 may operate with a soft access point and if a communication channel for communication with the user terminal device 200 is formed, scan at least one access point around the second electronic device 100, and control the communication interface 110 to transmit information about at least one access point to the user terminal device 200.

The processor 120 may receive information about one access point among at least one access point from the user terminal device 200 through the communication interface 110 and control the communication interface 110 to transmit a request for being connected to one access point among at least on access point based on information about one access point. Here, the information about one access point may include at least one of identification information of the one access point or a password of the one access point.

That is, an easy setup about the second electronic device 100 may be performed such that the processor 120 provides information about a connectable access point in the second electronic device 100 to the user terminal device 200 and the user terminal device 200 provides information about one access point among connectable access points in the second electronic device 100 to the second electronic device 100.

In FIG. 3, it is described that the processor 120 receives information about one access point among at least one access point from the user terminal device 200 but the disclosure is not limited thereto. For example, the processor 120 may scan a plurality of access points around the second electronic device 100, transmit information about the plurality of access points to the user terminal device 200, and receive information about two or more access points among the plurality of access points from the user terminal device 200. In this case, the processor 120 may be connected to an access point of which signal strength is the greatest among two or more access points.

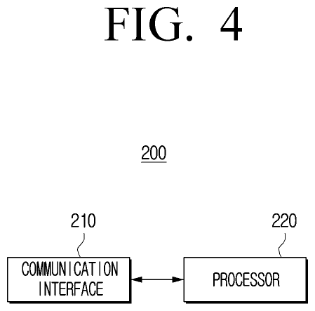

FIG. 4 is a block diagram illustrating a configuration of a user terminal device 200 according to an embodiment. According to FIG. 4, the user terminal device 200 includes a communication interface 210 and a processor 220.

The communication interface 210 is a configuration performing communication with various types of external devices according to various types of communication methods. For example, the user terminal device 200 may perform communication with the second electronic device 100, the first electronic device 300, or the access point 400 through the communication interface 210.

The communication interface 210 may include a Wi-Fi module, a Bluetooth module, an infrared communication module, a wireless communication module, etc. Here, each communication module may be implemented in a form of at least one hardware chip.

The Wi-Fi module and the Bluetooth module perform communication in a Wi-Fi method and a Bluetooth method, respectively. In case of using the Wi-Fi module or the Bluetooth module, the module may receive and transmit various connection information such as a SSID and a session key in advance, connect communication by using the connection information, and then receive and transmit various information. The infrared communication module may perform communication based on an infrared data association (IrDA) technology which transmits data wirelessly in a short distance by using infrared light between visible light and a millimeter wave.

The wireless communication module may include at least one communication chip performing communication according to various wireless communication standards such as Zigbee, a 3rd generation (3G), a 3rd generation partnership project (3GPP), long term evolution (LTE), LTE Advanced (LTE-A), a 4th generation (4G), and a 5th generation (5G).

Otherwise, the communication interface 210 may include a wired communication interface such as a HDMI, DP, Thunderbolt, a USB, RGB, a D-SUB, a DVI, or the like.

Besides, the communication interface 210 may include at least one of a local area network (LAN) module, an Ethernet module, or a wired communication module performing communication by using a pair cable, a coaxial cable, a fiber optic cable, or the like.

The communication interface 210 may be implemented as one communication interface or may be implemented as a plurality of communication interfaces. Meanwhile, hereinafter, for convenience of the description, operations of the user terminal device 200 are described based on the expression “communication interface 210”.

The processor 220 controls operations of the user terminal device 200 overall. Specifically, the processor 220 may be connected to each component of the user terminal device 200 to control operations of the user terminal device 200 overall. For example, the processor 220 may be connected to a component such as the communication interface 110, a display (not shown), memory (not shown), a user interface (not shown), or the like to control operations of the user terminal device 200.

At least one processor 220 may include one or more of a Central Processing Unit (CPU), a Graphics Processing Unit (GPU), an Accelerated Processing Unit (APU), a Many Integrated Core (MIC), a Digital Signal Processor (DSP), a Neural Processing Unit (NPU), a hardware accelerator, or a machine learning accelerator. The at least one processor 220 may control one or any combination of other components of the user terminal device 200 and perform an operation related to communication or data processing. The at least one processor 220 may perform one or more programs or instructions stored in the memory. For example, the at least one processor 220 may perform a method according to an embodiment of the disclosure by executing one or more instructions stored in the memory.

If a method according to an embodiment of the disclosure includes a plurality of operations, the plurality of operations may be performed by one processor and may be performed by a plurality of processors. For example, when a first operation, a second operation, and a third operation are performed by a method according to an embodiment, all of the first operation, the second operation, and the third operation may be performed by a first processor and also, the first operation and the second operation are performed by the first processor (e.g. a general purpose processor) and the third operation may be performed by a second processor (e.g. an Artificial Intelligence (AI)-dedicated processor).

The at least one processor 220 may be implemented as a single core processor including one core and may be implemented as one or more multi core processors including a plurality of cores (e.g. homogeneous multicores or heterogeneous multicores). If the at least one processor 220 is implemented as a multi core processor, each of the plurality of cores included in the multi core processor may include processor internal memory such as cache memory and on-chip memory, wherein a common cache shared by the plurality of cores may be included in the multi core processor. Also, each of the plurality of cores included in the multi core processor (or part of the plurality of cores) may read and perform program instructions for independently implementing a method according to an embodiment of the disclosure and also, may read and perform program instructions for implementing a method according to an embodiment of the disclosure in connection with all (or part) of the plurality of cores.

If a method according to an embodiment of the disclosure includes a plurality of operations, the plurality of operations may be performed by one core among the plurality of cores included in the multi core processor and may be performed by the plurality of cores. For example, when a first operation, a second operation, and a third operation are performed by a method according to an embodiment, all of the first operation, the second operation, and the third operation may be performed by a first core included in the multi core processor and also, the first operation and the second operation may be performed by the first core included in the multi core processor and the third operation may be performed by a second core included in the multi core processor.

In embodiments of the disclosure, at least one processor 220 may mean a System on Chip (SoC) onto which one or more processors and other electronic components are integrated, a single core processor, a multi core processor, or a core included in the single core processor or the multi core processor, wherein the core may be implemented as a CPU, a GPU, an APU, a MIC, a DSP, a NPU, a hardware accelerator, or a machine learning accelerator but embodiments of the disclosure are not limited thereto. Meanwhile, hereinafter, for convenience of the description, operations of the user terminal device 200 are described based on the expression “processor 220”.

The processor 220 may receive information about the first access point from the first electronic device 300 through the communication interface 210 and if a communication channel for communication with the second electronic device 100 is formed, may receive information about at least one second access point from the second electronic device 100 through the communication interface 210.

Meanwhile, the disclosure is not limited thereto and the processor 220, if a communication channel for communication with the second electronic device 100 is formed, may receive information about the first access point from the first electronic device 300 through the communication interface 210 and receive information about at least one second access point from the second electronic device 100.

The processor 220, if the first access point is included in the at least one second access point, may control the communication interface 210 to transmit information about the first access point to the second electronic device 100.

That is, the processor 220 may not receive information about the access point 400 transmitted to the second electronic device 100 from the user but may receive it from the first electronic device 300. Accordingly, the user does not need to input information about the access point 400 and thus user convenience may be improved.

As above, it is described that the processor 220 receives information about the first access point from the first electronic device 300 but the disclosure is not limited thereto. For example, the processor 220 may receive information about an access point to which each of a plurality of first electronic devices is connected from each of the plurality of first electronic devices. The processor 220 may transmit information about an access point included in at least one second access point among access points to which each of the plurality of first electronic devices is connected to the second electronic device 100. In this case, the processor 220 may transmit information about two or more access points to the second electronic device 100. Otherwise, the processor 220, even if receiving information about an access point to which each of the plurality of first electronic devices is connected from each of the plurality of first electronic devices, may transmit information about one access point to the second electronic device 100 based on signal strength of each access point.

The user terminal device 200 may further include a display, wherein the processor 220, if the first access point is not included in the at least one second access point, may control the display to display a screen for receiving the information about the first access point. For example, the processor 220, if the first access point is not included in the at least one second access point, may display at least one second access point, and if one of them is selected by the user, may display a screen for receiving a password of the selected second access point, and then if the password is inputted by the user, may provide identification information of the selected second access point and a password of the selected second access point to the second electronic device 100. Hereinafter, this operation is referred to as an easy setup.

Also, the processor 220 may identify signal strength of the first access point in the second electronic device 100 based on information about the at least one second access point, and if the signal strength is equal to or greater than preset signal strength, may control the communication interface 210 to transmit the information about the first access point to the second electronic device 100. The processor 220 may manually perform an easy setup if signal strength of the first access point is less than the preset signal strength.

Otherwise, information about the first access point may include first signal strength of the first access point in the first electronic device 300, wherein the processor 220 may identify second signal strength of the first access point in the second electronic device 100 based on the information about the at least one second access point, and if the second signal strength is equal to or greater than the first signal strength or the preset signal strength, may control the communication interface 210 to transmit the information about the first access point to the second electronic device 100. That is, the processor 220, even if the second signal strength of the first access point is less than preset signal strength, if it is equal to or greater than the first signal strength of the first access point in the first electronic device 300, may transmit information about the first access point to the second electronic device 100. The processor 220, if second signal strength of the first access point is less than the first signal strength and the preset signal strength, may manually perform an easy setup.

Also, the user terminal device 200 may further include a display, wherein the processor 220, if the preset application is executed, may control the display to display a list about at least one electronic device related to the application, and if the second electronic device is selected among the at least one electronic device, may receive the information about the first access point from the first electronic device 300 through the communication interface 210.

The processor 220, if the second electronic device being selected among the at least one electronic device, may control the communication interface 210 to transmit a signal requesting information about access points of which each is connected to the at least one electronic device.

For example, the processor 220, if the IoT application is executed, may display a list about at least one electronic device registered at the IoT application and if the second electronic device is selected among at least one electronic device, transmit a signal requesting information about access points of which each is connected to the at least one electronic device, and receive information about the first access point from the first electronic device 300.

Also, the processor 220, if the second electronic device and a position corresponding to the second electronic device is selected, may receive the information about the first access point and information about a position of the first electronic device 300 from the first electronic device 300 through the communication interface 210, and if the position of the first electronic device 300 and the position of the second electronic device 100 are identical and the first access point is included in the at least one second access point, may control the communication interface 210 to transmit the information about the first access point to the second electronic device 100. The processor 220, if the position of the first electronic device 300 and the position of the second electronic device 100 are not identical or the first access point is not included in the at least one second access point, may manually perform an easy setup.

Otherwise, the processor 220, if the second electronic device 100 and a position corresponding to the second electronic device 100 are selected, may receive information about a plurality of first access points and information of a position of a plurality of first electronic devices 300 from the plurality of first electronic devices 300 through the communication interface 210. In this case, the processor 220, if two or more first access points are included in at least one second access point, may transmit information about the first access point to which the first electronic device arranged on the same position with that of the second electronic device 100 is connected to the second electronic device 100.

The information about the first access point may include at least one of identification information of the first access point or a password of the first access point. Otherwise, the information about the first access point may include at least one of identification information of the first access point, a password of the first access point, or signal strength of the first access point.

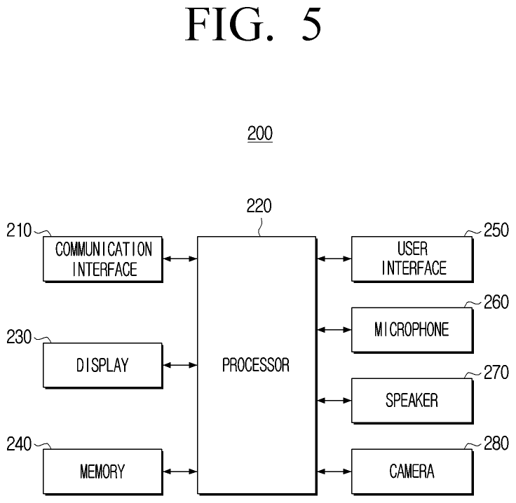

FIG. 5 is a block diagram illustrating a detailed configuration of a user terminal device according to an embodiment. The user terminal device 200 may include the communication interface 210 and the processor 220. Also, according to FIG. 5, the user terminal device 200 may further include a display 230, memory 240, a user display 250, a microphone 260, a speaker 270, and a camera 280. The detailed description of components overlapped with the components shown in FIG. 4 among the components shown in FIG. 5 is omitted.

The display 230 is a configuration for displaying an image and may be implemented as displays having various forms such as a liquid crystal display (LCD), an organic light emitting diode (OLED) display, and a plasma display panel (PDP). The display 230 may include a driving circuit which may be implemented in a form such as an a-si TFT, a low temperature poly silicon (LTPS) TFT, or an organic TFT (OTFT), a backlight unit, or the like therein. Meanwhile, the display 230 may be implemented as a touch screen coupled to a touch sensor, a flexible display, a 3D display, or the like.

The memory 240 may be referred to as hardware storing information such as data in an electric or magnetic form in order that the processor 220 or the like may access thereto. For the above, the memory 240 may be implemented as at least one hardware of non-volatile memory, volatile memory, flash memory, a hard disk drive (HDD) or a solid state drive (SDD), RAM, or ROM.

The memory 240 may store at least one instruction required for an operation of the user terminal device 200 or the processor 220. Here, the instruction may be written in a machine language, which is a computer-understandable language as a code unit instructing an operation of the user terminal device 200 or the processor 220. Otherwise, the memory 240 may store a plurality of instructions performing specific work of the user terminal device 200 or the processor 220 as an instruction set.

The memory 240 may store data which is information in a bit or bite unit indicating a character, a number, an image, or the like. For example, the memory 240 may store information about the easy setup, information about the access point 400, etc.

The memory 240 may be accessed by the processor 220, wherein the processor 220 may perform reading/recording/correcting/deleting/renewing, or the like with respect to the instructions, the instruction set, or data.

The user interface 250 may be implemented as a button, a touch pad, a mouse, a keyboard, or the like or may be implemented as a touch screen which may also perform together the display function and the manipulation input function. Here, the button may be various types of buttons such as a mechanical button, a touch pad, or a wheel formed at any area such as a front part, a side part, a rear part, or the like of an appearance of a body of the user terminal device 200.

The microphone 260 is a configuration for receiving sound and converting the sound to an audio signal. The microphone 260 may be electrically connected to the processor 220 and receive sound by control of the processor 220.

For example, the microphone 260 may be formed as an integral type as being integrated into an upper side of the user terminal device 200 or into the user terminal device in a front direction, a side direction, or the like. Otherwise, the microphone 260 may be included in a remote controller separate from the user terminal device 200. In this case, the remote controller may receive sound through the microphone 260 and may provide the received sound to the user terminal device 200.

The microphone 260 may include various components such as a microphone collecting sound in an analog form, an amplifier circuit amplifying the collected sound, an A/D conversion circuit sampling and converting the amplified sound to digital sound, and a filter circuit removing a noise component from the converted digital signal.

Meanwhile, the microphone 260 may be implemented in a form of a sound sensor, wherein any type of configuration is proper if the configuration may collect sound.

The speaker 270 is a component outputting not only various audio data processed in the processor 220 but also various alarms, voice messages, or the like.

Besides, the user terminal device 200 may further include the camera 280. The camera 280 is a configuration for capturing a static image or a moving image. The camera 280 may capture a static image of a specific time point but may successively capture the static image.

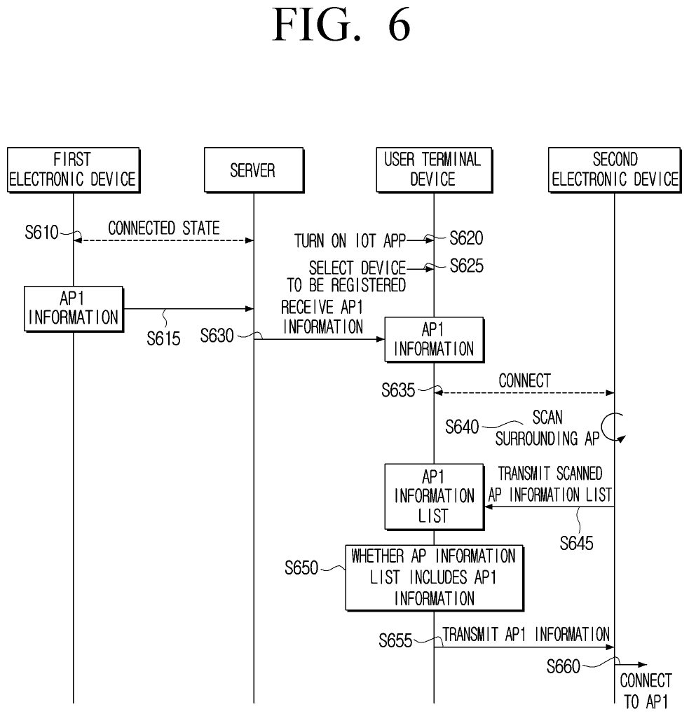

As above, the user terminal device 200 may transmit information about the access point 400 received from the first electronic device 300 to the second electronic device 100 to perform the easy setup without an operation of inputting a password of the user, etc. Hereinafter, operations of the electronic device 100 and the user terminal device 200 are more specifically described with reference to FIGS. 6 to 8. In FIGS. 6 to 8, individual examples are described for convenience of the description. Meanwhile, the individual examples of FIGS. 6 to 8 may be embodied in any combined state.

FIG. 6 is a sequence diagram illustrating an easy setup according to an embodiment.

First, a first electronic device 300 is in a state of being connected with a server (S610). Here, the server is an IoT server and may store information about the first electronic device 300 and be connected by a user terminal device 200.

The first electronic device 300 may provide information about an access point 1 to the server. Here, the information about the access point 1 may include at least one of identification information of an access point to which the first electronic device 300 is connected, a password, or signal strength.

A user may execute an IoT application through the user terminal device 200 (S620) and may select a device to be registered (S625). The user terminal device 200, if the device to be registered is selected as the second electronic device 100, may receive the information about the access point 1 from the server (S630).

If a communication channel is formed between the user terminal device 200 and the second electronic device 100 operating with a soft access point (S635), the second electronic device 100 may scan a surrounding access point (S640) and may transmit a list about the scanned access point to the user terminal device 200 (S645).

The user terminal device 200 may identify whether the list about the access point includes information about the access point 1 (S650) and in case of including, may transmit the information about the access point 1 to the second electronic device 100 (S655). Otherwise, the user terminal device 200, if the list about the access point includes information about the access point 1 and signal strength of the access point 1 in the list about the access point is equal to or greater than preset signal strength, may transmit information about the access point 1 to the second electronic device 100.

The second electronic device 100 may be connected to the access point 1 based on information about the access point 1 received from the user terminal device 200 (S660).

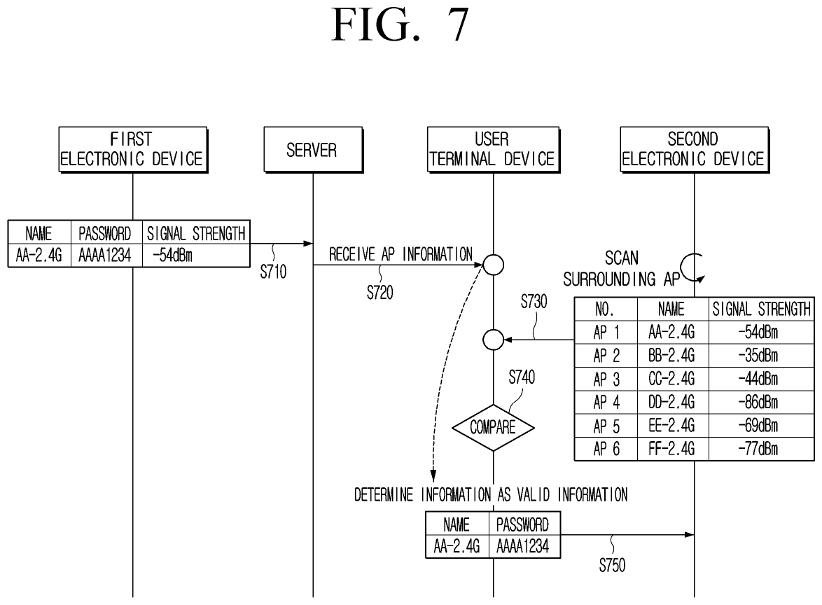

FIG. 7 is a sequence diagram illustrating a data flow according to an embodiment.

In advance, a first electronic device 300 may provide identification information about an access point to which the first electronic device 300 is connected, a password, and signal strength to a server (S710).

The server may provide information received from the first electronic device 300 to a user terminal device 200 (S720).

A second electronic device 100 may scan a surrounding access point and provide a list about the access point to the user terminal device 100 (S730). Here, the list about the access point may include an identification number and signal strength of each of at least one access point.

The user terminal device 200 may compare the list about the access point with information about the access point to which the first electronic device 300 is connected (S740) and if the information is identified as valid information, may transmit the information about the access point to which the first electronic device 300 is connected to the second electronic device 100 (S750).

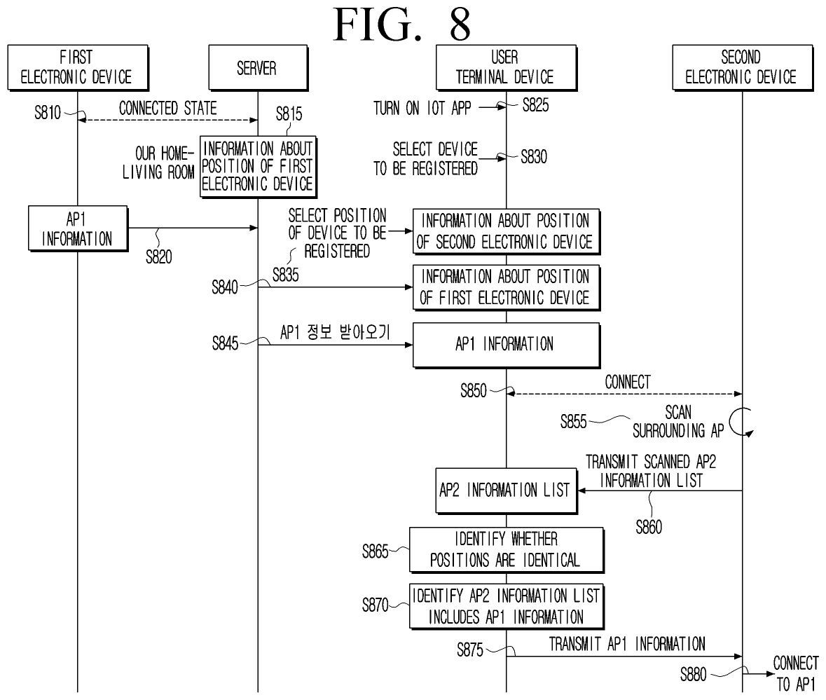

FIG. 8 is a sequence diagram illustrating an easy setup in consideration of position information according to an embodiment.

First, a first electronic device 300 is in a state of being connected with a server (S810). Here, the server is an IoT server and may store information about the first electronic device 300 and be connected by a user terminal device 200. Also, the server is in a state of storing information about a position of the first electronic device 300 (S815).

The first electronic device 300 may provide information about an access point 1 to the server (S820). Here, the information about the access point 1 may include at least one of identification information of an access point to which the first electronic device 300 is connected, a password, or signal strength.

A user may execute an IoT application through the user terminal device 200 (S825), select a device to be registered (S835), and then may input information about a position of the device to be registered (S835). The user terminal device 200, if the device to be registered is selected as the second electronic device 100, may receive the information about the position of the first electronic device 300 from the server (S845) and receive information about the access point 1 from the server (S845).

If a communication channel is formed between the user terminal device 200 and the second electronic device 100 operating with a soft access point (S850), the second electronic device 100 may scan a surrounding access point (S855) and may transmit a list about the scanned access point 2 to the user terminal device 200 (S860).

The user terminal device 200 may identify whether a position of the first electronic device 300 and a position of the second electronic device 100 are identical (S865) and identify whether the list about the access point 2 includes information about the access point 1 (S870). The user terminal device 200, if the position of the first electronic device 300 and the position of the second electronic device 100 are identical and the list about the access point 2 includes information about the access point 1, may transmit information about the access point 1 to the second electronic device 100 (S875). Otherwise, the user terminal device 200, if the position of the first electronic device 300 and the position of the second electronic device 100 are identical, the list about the access point 2 includes information about the access point 1, and signal strength of the access point 1 in the second electronic device 100 is equal to or greater than the preset signal strength, or the signal strength of the access point 1 in the second electronic device 100 is equal to or greater than the signal strength of the access point 1 in the first electronic device 300, may transmit the information about the access point 1 to the second electronic device 100.

The second electronic device 100 may be connected to the access point 1 based on information about the access point 1 received from the user terminal device 200 (S880).

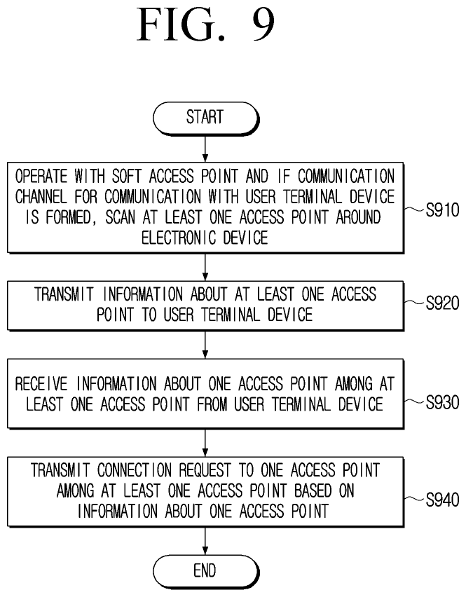

FIG. 9 is a flow chart illustrating a method of controlling an electronic device according to an embodiment.

First, the method includes operating with a soft access point and if a communication channel for communication with a user terminal device is formed, scanning at least one access point around the electronic device (S910). Then, the method includes transmitting information about at least one access point to the user terminal device (S920). Further, the method includes receiving information about one access point among at least one access point from the user terminal device (S930). Still further, the method includes transmitting a connection request to one access point among the at least one access point based on information about one access point (S940).

Also, the information about one access point may include at least one of identification information of the one access point or a password of the one access point.

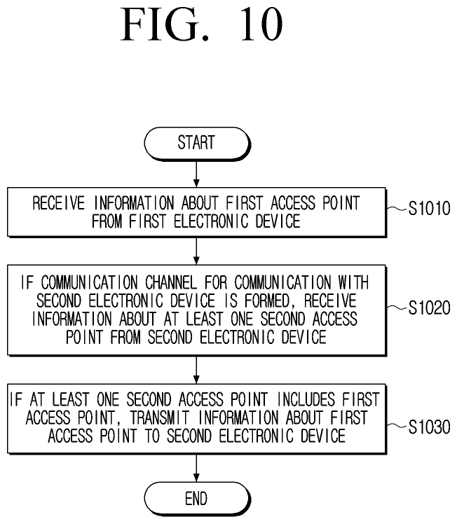

FIG. 10 is a flow chart illustrating a method of controlling a user terminal device according to an embodiment.

First, the method includes receiving information about a first access point from a first electronic device (S1010). Then, the method includes if a communication channel for communication with a second electronic device is formed, receiving information about at least one second access point from the second electronic device (S1020). Further, the method includes, if the at least one second access point includes the first access point, transmitting information about the first access point to second electronic device (S1030). Here, the transmitting (S1030) may include identifying signal strength of the first access point in the second electronic device based on information about the at least one second access point, and if the signal strength is equal to or greater than preset signal strength, transmitting the information about the first access point to the second electronic device.

Further, information about the first access point may include first signal strength of the first access point in the first electronic device, wherein the transmitting (S1030) may include identifying second signal strength of the first access point in the second electronic device based on the information about the at least one second access point, and if the second signal strength is equal to or greater than the first signal strength or the preset signal strength, transmitting the information about the first access point to the second electronic device.

Meanwhile, the method may include, if a preset application is executed, displaying a list about at least one electronic device related to the application, wherein the receiving the information about the first access point (S1010) may include, if the second electronic device is selected among the at least one electronic device, receiving the information about the first access point from the first electronic device.

Here, the receiving the information about the first access point may include, if the second electronic device is selected among the at least one electronic device, transmitting a signal requesting information about access points of which each is connected to the at least one electronic device.

Otherwise, the receiving the information about the first access point may include, if the second electronic device and a position corresponding to the second electronic device are selected, receiving the information about the first access point and information about a position of the first electronic device from the first electronic device, and the transmitting (S1030) may include, if the position of the first electronic device and the position of the second electronic device are identical and the first access point is included in the at least one second access point, transmitting the information about the first access point to the second electronic device.

Meanwhile, the method may further include, if the first access point is not included in the at least one second access point, displaying a screen for receiving the information about the first access point.

Also, the information about the first access point may include at least one of identification information of the first access point or a password of the first access point.

As above, according to various embodiments of the disclosure, the user terminal device may transmit information about the access point received from the first electronic device to the second electronic device and may perform the easy setup without an operation of inputting a password of the user, etc.

Meanwhile, according to an embodiment of the disclosure, various examples described above may be implemented as software including instructions stored in machine (e.g. a computer) readable storage media. The machine refers to a device which calls instructions stored in the storage media and is operable according to the called instructions, wherein the machine may include an electronic device (e.g. an electronic device A) according to the disclosed embodiments. If the instructions are executed by a processor, the processor may perform a function corresponding to the instructions directly or by using other components under control of the processor. The instructions may include a code generated or executed by a compiler or an interpreter. A machine readable storage medium may be provided in a form of a non-transitory storage medium. Here, the term ‘non-transitory’ merely means that the storage medium does not include a signal and is tangible, wherein the term does not distinguish a case that data is stored in the storage medium semipermanently from a case that data is stored in the storage medium temporarily.

Also, according to an embodiment of the disclosure, a method according to various examples described above may be provided to be included in a computer program product. The computer program product may be traded between a seller and a buyer as goods. The computer program product may be distributed in a form of a machine readable storage medium (e.g. compact disc read only memory (CD-ROM)) or on-line via an application store (e.g. Play Store™). In the case of on-line distribution, at least part of the computer program product may be stored at least temporarily or may be generated temporarily in a storage medium such as memory of a server of a manufacturer, a server of an application store, or a relay server.

Also, according to an embodiment of the disclosure, various embodiments described as above may be implemented in a recording medium that may be read by a computer or a device similar thereto by using software, hardware, or a combination thereof. In some cases, embodiments described in the specification may be implemented as a processor itself. According to software implementation, embodiments such as procedures and functions described in the specification may be also implemented as separate software. Each software may perform one or more functions and operations described in the specification.

Meanwhile, computer instructions for performing the processing operation of the machine according to the various embodiments above may be stored in a non-transitory computer readable medium. Computer instructions stored in this non-transitory computer readable medium that, when executed by a processor of a specific device, causes the specific device to perform a processing operation of the device according to the various embodiments. The non-transitory computer readable medium does not mean a medium that stores data for a short time such as a resistor, a cache, memory, or the like but a machine readable medium that stores data semipermanently. A specific example of the non-transitory computer readable medium may be a CD, a DVD, a hard disk, a Blu-ray disk, a USB, a memory card, ROM, etc.

Also, each of components (e.g. a module or a program) according to the various embodiments above may be configured as a single item or a plurality of items, wherein a partial subcomponent of the aforementioned relevant subcomponents may be omitted or another subcomponent may be further included in various embodiments. Mostly or additionally, some components (e.g. a module or a program) may be integrated into one item and may identically or similarly perform a function implemented by each of the relevant components before the integration. According to various embodiments, operations performed by a module, a program, or another component may be executed sequentially, in parallel, repetitively, or heuristically, or at least part of the operations may be executed in different orders or be omitted, or another operation may be added.

As the above, preferable examples of the present disclosure are shown and described. However, it is obvious that the disclosure is not limited to the aforementioned specific examples and various modifications may be implemented by those skilled in the art without deviating from the gist of the disclosure claimed in the scope of claims, wherein these modifications should not be independently understood from the technical spirit or prospect of the disclosure.

What is claimed is:

1. An electronic device, comprising:
a communication interface; and
at least one processor, connectable to the communication interface to control the electronic device, such that while the at least one processor is connected to the communication interface, the at least one processor is configured to:
based on a channel for communication with a user terminal device being formed by operating as a soft access point, scan for at least one access point around the electronic device;
control the communication interface to transmit information related to the at least one access point obtained based on the scan to the user terminal device;
receive information related to one access point among the at least one access point from the user terminal device through the communication interface; and
control the communication interface to transmit a connection request to the one access point among the at least one access point based on the information related to the one access point.

2. The electronic device of claim 1, wherein the information related to the one access point includes:
at least one of identification information of the one access point or a password of the one access point.

3. A user terminal device, comprising:
a communication interface; and
at least one processor, connectable to the communication interface to control the user terminal device, such that while the at least one processor is connected to the communication interface, the at least one processor is configured to:
receive information related to a first access point from a first electronic device through the communication interface;
based on a channel for communication with a second electronic device being formed, receive information related to at least one second access point from the second electronic device through the communication interface; and
based on the first access point being included among the information related to the at least one second access point, control the communication interface to transmit the information related to the first access point to the second electronic device.

4. The user terminal device of claim 3, wherein the at least one processor is configured to:
identify a signal strength of the first access point in the second electronic device based on the information related to the at least one second access point; and
based on the signal strength being equal to or greater than a preset signal strength, control the communication interface to transmit the information related to the first access point to the second electronic device.

5. The user terminal device of claim 3, wherein the information related to the first access point includes a first signal strength of the first access point in the first electronic device,
wherein the at least one processor is configured to:
identify a second signal strength of the first access point in the second electronic device based on the information related to the at least one second access point; and
based on the second signal strength being equal to or greater than the first signal strength or a preset signal strength, control the communication interface to transmit the information related to the first access point to the second electronic device.

6. The user terminal device of claim 3, further comprising:
a display,
wherein the at least one processor is configured to:
based on an application being executed, control the display to display a list related to at least one electronic device related to the application; and
based on the second electronic device being selected among the at least one electronic device, receive the information related to the first access point from the first electronic device through the communication interface.

7. The user terminal device of claim 6, wherein the at least one processor is configured to:
based on the second electronic device being selected among the at least one electronic device, control the communication interface to transmit a signal requesting information related to access points connected to the at least one electronic device.

8. The user terminal device of claim 6, wherein the at least one processor is configured to:
based on the second electronic device and a position corresponding to the second electronic device being selected, receive the information related to the first access point and information related to a position of the first electronic device from the first electronic device through the communication interface; and
based on the position of the first electronic device and the position of the second electronic device being identical and the first access point being included in the at least one second access point, control the communication interface to transmit the information related to the first access point to the second electronic device.

9. The user terminal device of claim 3, further comprising:
a display,
wherein the at least one processor is configured to:
based on the first access point being not included among the information related to the at least one second access point, control the display to display a screen for receiving the information related to the first access point.

10. The user terminal device of claim 3, wherein the information related to the first access point includes at least one of identification information of the first access point or a password of the first access point.

11. A control method of an electronic device, comprising:
based on a channel for communication with a user terminal device being formed by operating with a soft access point, scanning for at least one access point around the electronic device;
transmitting information related to at least one access point to the user terminal device;
receiving the information related to one access point among the at least one access point from the user terminal device; and
transmitting a connection request to the one access point among the at least one access point based on the information related to the one access point.

12. The control method of claim 11, wherein the information related to the one access point includes at least one of identification information of the one access point or a password of the one access point.

13. A method of controlling a user terminal device, comprising:
receiving information related to a first access point from a first electronic device;
based on a channel for communication with a second electronic device being formed, receiving information related to at least one second access point from the second electronic device; and
based on the first access point being included among the information related to the at least one second access point, transmitting information related to the first access point to the second electronic device.

14. The method of claim 13, wherein the transmitting includes:
identifying a signal strength of the first access point in the second electronic device based on the information related to the at least one second access point; and
based on the signal strength being equal to or greater than preset signal strength, transmitting the information related to the first access point to the second electronic device.

15. The method of claim 13, wherein the information related to the first access point includes a first signal strength of the first access point in the first electronic device,
wherein the transmitting includes:
identify a second signal strength of the first access point in the second electronic device based on the information related to the at least one second access point; and
based on the second signal strength being equal to or greater than the first signal strength or a preset signal strength, transmitting the information related to the first access point to the second electronic device.
